(19) United States
(12) Patent Application Publication
(10) Pub. No.: US 2003/0069022 A1
(43) Pub. Date: Apr. 10, 2003

(54) Amplitude cancellation topology for multichannel applications

(76) Inventors: Mark Kintis, Manhattan Beach, CA (US); James B. Wade, Redondo Beach, CA (US); Mark V. Keller, Palos Verdes Estates, CA (US); Robert R. Harnden, Redondo Beach, CA (US)

Correspondence Address: PATENT COUNSEL, TRW INC., S & E LAW DEPT., ONE SPACE PARK, BLDG. E2/6051, REDONDO BEACH, CA, 90278, US

(21) Appl. No.: 09/971,741

(22) Filed: Oct. 4, 2001

(51) Int. Cl. H04Q 7/20

(52) U.S. Cl. 455/452; 455/450

(57) ABSTRACT

A multichannel dynamic range adaptor (102) includes a multichannel signal input (116) for carrying an input signal with an input bandwidth spanning multiple communication channels, and a multichannel signal attenuator (118) connected to the multichannel signal input (116). The multichannel signal attenuator (118) includes a signal output (120) and a signal attenuation input (134) responsive to an attenuation control signal. The multichannel signal attenuator (118) is adapted to provide, on the signal output (120), an output signal corresponding to the input signal reduced in dynamic range in accordance with the attenuation control signal. The output signal dynamic range is generally constrained to be no greater than the dynamic range capability (e.g., 60 dB or less) of an analog to digital (A/D) converter (122) coupled to the multichannel signal attenuator (118) for digitizing the output signal.

### CROSS-REFERENCE TO RELATED APPLICATIONS

This application is related to TRW Docket No. 12-1214, titled “Intermediate Frequency Signal Amplitude Equalizer for Multichannel Applications”, filed concurrently herewith, as Serial No. ______.

### BACKGROUND OF THE INVENTION

Many types of wireless communication services have emerged in a relatively short period of time. Service subscribers, in turn, have quickly discovered the significant benefits in convenience and accessibility stemming from wireless communication. As a result, wireless communications services have advanced quickly into a position of popularity and profitability.

Generally, a wireless communication transmitter transmits information to a subscriber in a “channel”. A channel represents a portion of electromagnetic spectrum having a predetermined bandwidth in which signal information resides. As one example, the European Global System Mobile (GSM) defines 200 KHz wide channels with 200 KHz spacing starting at 880 MHz.

In certain wireless applications, a single receiver processes multiple individual channels in order to recover the signal information present in each channel. In the past, such receivers included a separate processing chain for each channel. The processing chain generally included, for example, a local IF oscillator and mixer (for converting a transmitted frequency to a first working frequency), a bandpass filter (for isolating a channel), a second IF oscillator and mixer (for downconverting the isolated channel for further processing), and an Analog to Digital converter (for digitizing the downconverted isolated channel).

By processing channels individually, the receiver relaxed certain design requirements for the processing chain. For example, off the shelf low bandwidth A/D converters with 60 dB dynamic range were capable of digitizing the relatively narrow bandwidth downconverted isolated channel. However, a receiver that included multiple processing chains incurred significant cost increases arising from the duplication of processing chain components for each channel.

As a result, designers proposed an alternative receiver implementation that used a single bulk processing chain to recover signal information from multiple channels. The bulk processing chain included an IF local oscillator and mixer (for converting a transmitted frequency to a first working frequency), a bandpass filter (for isolating multiple channels in a wide slice of bandwidth), a second IF local oscillator and mixer (for further downconverting the wide slice of bandwidth for additional processing), and a single A/D converter (for digitizing the slice of spectrum spanning the multiple channels). The bulk processing chain further included a channelizer following the A/D converter for separating out individual channels after digitization.

However, an A/D converter capable of digitzing a wide slice of bandwidth must meet the dynamic range requirements of that wide slice of bandwidth. Thus, digitizing a slice of bandwidth spanning more than 10-20 channels required that the bulk processing chain include an A/D converter with extremely large dynamic range (e.g., 90 dB or more). Such A/D converters are not presently available.

A need has long existed in the industry for an amplitude cancellation topology that addresses the problems noted above and others previously experienced.

### BRIEF SUMMARY OF THE INVENTION

A preferred embodiment of the present invention provides a multichannel dynamic range adaptor. The dynamic range adaptor includes a multichannel signal input that carries an input signal with an input bandwidth spanning multiple communication channels, and a multichannel signal attenuator connected to the multichannel signal input. The multichannel signal attenuator includes a signal output and a signal attenuation input responsive to an attenuation control signal. The multichannel signal attenuator is adapted to provide, on the signal output, an output signal corresponding to the input signal reduced in dynamic range in accordance with the attenuation control signal.

Thus, for example, the output signal dynamic range may be constrained to be no greater than the dynamic range capability (e.g., 60 dB or less) of an analog to digital (A/D) converter coupled to the multichannel signal attenuator for digitizing the output signal. Similarly, the input bandwidth (which generally spans multiple wireless communication channels) is generally no greater than the bandwidth capability of the A/D converter. The wireless communication channels may be, for example, European Global System Mobile (GSM) or North American Interim Standard (IS) communication channels.

As one example, the multichannel signal attenuator may be a reactive power summer. Thus, the multichannel signal attenuator is operative to subtract the attenuation control signal from the input signal to reduce the dynamic range of the input signal. To that end, the attenuation control signal includes signal attenuation information for one or more communication channels. The attenuation information may be, for example, scaled signal information obtained from a prior input signal.

To obtain the input signal, the multichannel dynamic range adaptor may include a first local oscillator and mixer for downconverting a bandlimited received signal, and a first bandpass filter spanning the input bandwidth and coupled to the first mixer. Optionally, further downconversion prior to amplitude adapation and digitization may be performed by a second local oscillator and mixer coupled to the first bandpass filter for downconverting the output signal, and a second bandpass filter spanning the input bandwidth and coupled to the multichannel signal attenuator.

A preferred embodiment of the invention may also be provided in a method for modifying dynamic range of an input signal. The method includes obtaining an input signal with an input bandwidth spanning multiple communication channels, coupling the input signal through a multichannel signal attenuator, and reducing input signal dynamic range in accordance with an attenuation control signal. The method thereby generates an output signal with reduced dynamic range on a signal output of the multichannel equalizer.

### BRIEF DESCRIPTION OF THE DRAWINGS

FIG. 1 illustrates a multichannel receiver.

FIG. 2 shows an implementation of a multiplexer.

FIG. 3 illustrates a delay compensating multichannel receiver according to an alternative embodiment of the present invention.

FIG. 4 depicts a flow diagram for modifying dynamic range of an input signal.

### DETAILED DESCRIPTION OF THE INVENTION

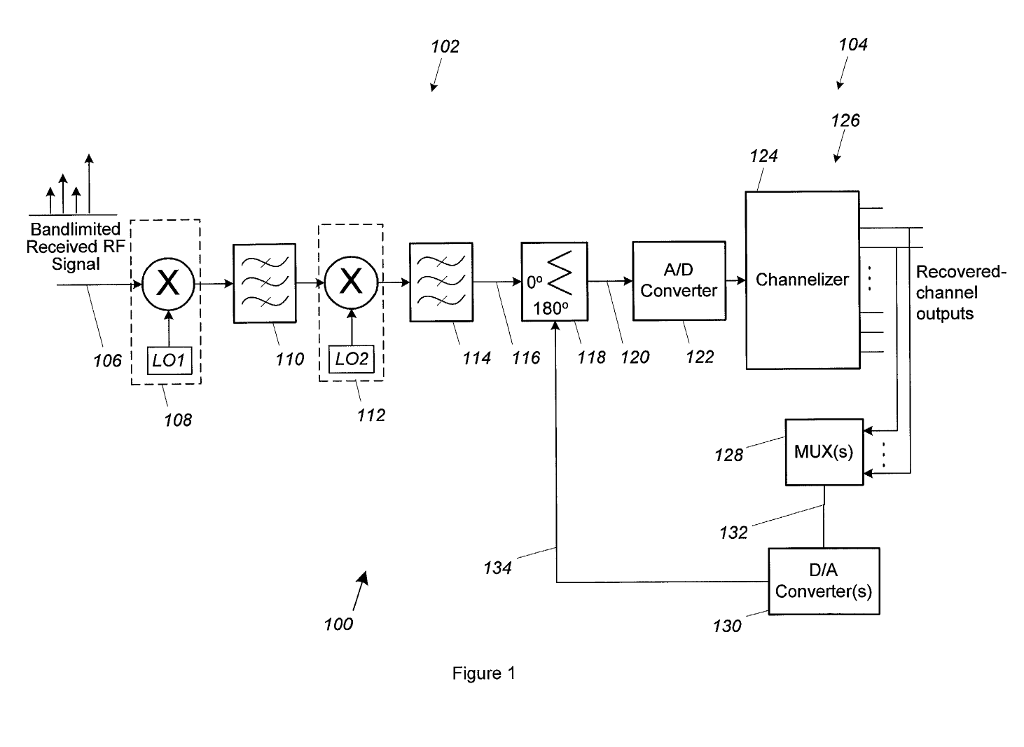

With reference first to FIG. 1, a multichannel receiver 100 includes a multichannel dynamic range adaptor front end 102 and a channel recovery and feedback back end 104. The front end 102 includes a bandlimited received signal input 106, a first local oscillator and mixer 108, a first bandpass filter 110, an optional second local oscillator and mixer 112, and an optional second bandpass filter 114. The front end 102 further includes a signal input 116, a multichannel signal attenuator 118, a signal output 120. In addition, an analog to digital (A/D) converter 122 couples to the signal output 120.

The back end 104 includes a channelizer 124 and recovered-channel outputs 126. The back end 104 further includes one or more multiplexers (e.g., the multiplexer 128) connected to one or more D/A converters (e.g., the D/A converter 130) over one or more summed channel cancellation outputs (e.g., the summed channel cancellation output 132). The multiplexer 128 provides attenuation control signal feedback to the multichannel signal attenuator 118 on a signal attenuation input 134.

The bandlimited received signal input 106 carries a received signal obtained, for example, from a reception antenna and bandlimiting fitter (not shown). The received signal generally has a very large bandwidth at very high frequencies (e.g., in the 900 MHz, 1.8 GHz, or 1.9 GHz GSM frequency space). Thus, the first local oscillator and mixer 108 provides a first downconversion to a first intermediate frequency (IF), while the first bandpass filter 110 severely attenuates frequency components outside of a preselected input bandwidth to provide the input signal for the multichannel signal attenuator 118.

As an example, the input signal may be centered at 189 MHz with a input bandwidth of 15 MHz. Other center frequencies and input bandwidths are also suitable, however. The input bandwidth determines the number of communication channels that the input signal spans or includes.

An input bandwidth of 15 MHz, for example, encompasses 75 Global System Mobile (GSM) channels. Each GSM channel is 200 KHz wide with 200 KHz spacing between channels. In certain GSM implementations, only every third frequency is used, and therefore 15 MHz spans 25 active channels. It is noted that in North America, the input bandwidth may be selected to span a reselected number of Interim Standard 54 or 136 (i.e., IS-54 or IS-136) communication channels instead. The invention is not limited to IS or GSM communication channels, however, or to any particular input bandwidth.

The multichannel signal attenuator 118, discussed in more detail below, selectively attenuates individual channels in the input signal. Thus, for example, communication channels that are excessively strong may be attenuated so that the output signal is a modified version of the input signal with dynamic range below a predetermined threshold (e.g., 60 dB or less) across the input bandwidth.

Optionally, the front end 102 includes the second local oscillator and mixer 112 and second bandpass filter 114. The second local oscillator and mixer 112 and second bandpass filter 114 provide downconversion of the output signal to a second IF (e.g., 16.3 MHz) suitable for subsequent processing by the multichannel signal attenuator 118.

The A/D converter 122 digitizes the output signal and provides output signal samples to the channelizer 124. The dynamic range threshold noted above is generally no greater than the dynamic range capability of the A/D converter 122. Similarly, the input bandwidth is generally no greater than the input bandwidth capability of the A/D converter 122.

Note that due to the controlled reduction in dynamic range of the input signal, the A/D converter 122 may, without aliasing or other artifacts, digitize the resultant output signal. As a result, the A/D converter 122 digitizes, in bulk, all the communication channels present in the output signal. The channelizer 124 then separates out individual channels and provides the individual channels as signal samples on the recovered-channel outputs 128. The channelizer 124 may be of conventional design, or may be a Discrete Fourier Transform channelizer such as that described in TRW Docket No. 12-1222, filed concurrently herewith, titled “Channelizer for Multichannel Receiver”, and incorporated herein by reference in its entirety.

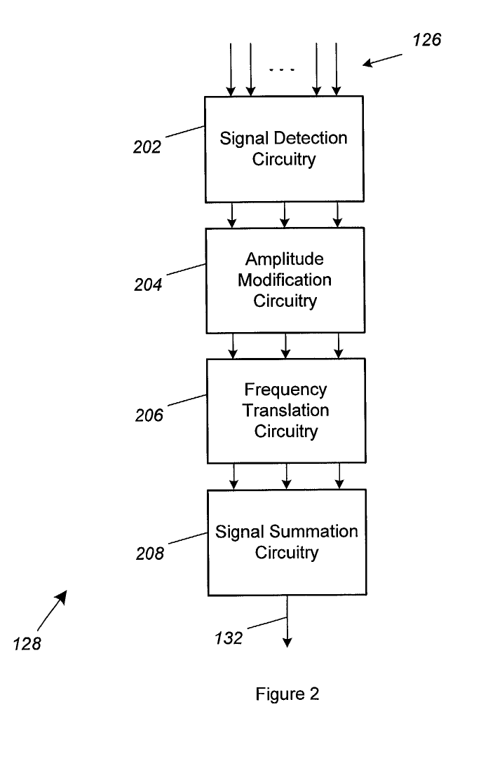

The multiplexer 128, which may be integral with or separate from the channelizer 124, is described in more detail below with respect to FIG. 2. The mulitplexer 128 provides an attenuation control signal to the multichannel signal attenuator 118 on the signal attenuation input 134. The attenuation control signal, in one implementation of the multichannel receiver 100, is an analog signal including scaled signal information for one or more channels. The multichannel signal attenuator 118 uses the scaled signal information to reduce dynamic range of the input signal.

To that end, the multichannel signal attenuator 118 may be implemented as reactive power summer. The reactive power summer subtracts (or adds 180 degrees out of phase) the attenuation control signal to the input signal. As a result, the scaled signal information is subtracted from the input signal. Thus, the overall dynamic range of the input signal is reduced when the scaled signal information attenuates strong channels present in the input signal.

The multiplexer 128 provides the scaled signal information present in the attenuation control signal. With reference to FIG. 2, that figure shows one implementation of the multiplexer 128. In particular, the multiplexer 128 includes signal detection circuitry 202 and amplitude modification circuitry 204. The multiplexer 128 further includes frequency translation circuitry 206 and signal summation circuitry 208. While the circuitry 202-208 may be implemented as discrete logic or arithmetic components, the circuitry 202-208 may also be implemented in a general purpose digital signal processor operating under programmed control to perform the functions detailed below. The multiplexer 128 preferably operates on complex baseband digital recovered-channel samples provided by the channelizer 124, although analog implementations of one or more portions of the circuitry 202-208 in the multiplexer 128 are also suitable.

The signal detection circuitry 202 accepts the recovered-channel samples and determines which communication channels exceed a predetermined threshold output level. The threshold output level may be the same or different for each communication channel. Preferably, the output level is an average energy level for the signal information (represented by the recovered-channel samples) in a communication channel. One or more selected channels that exceed the predetermined threshold are subject to attenuation in the input signal.

To that end, the amplitude modification circuitry 204 applies a scaling factor to the recovered-channel samples for the selected channels to form scaled signal information. The scaling factor may attenuate the recovered-channel samples by a fixed amount, for example, 3 dB or 6 dB, or may provide a multistep attenuation, for example, between 1-20 dB in 1-3 dB steps, with increasing attenuation applied when the selected channel continues to exceed the predetermined threshold.

Next, the frequency translation circuitry 206 frequency translates the scaled signal information (that is still baseband signal information) for each channel to the appropriate center frequency for that channel. For example, the frequency translation circuitry 206 may be implemented as a digital multiplier to frequency shift scaled signal information onto the appropriate 200 KHz communication channel center in the 900 MHz GSM frequency space.

Subsequently, the signal summation circuitry 208 adds together frequency translated scaled signal information for one or more channels to form a summed channel cancellation output signal. The summed channel cancellation output signal thus includes, in a single signal, scaled signal information for one or more communication channels with output levels that exceed one or more predetermined thresholds. The D/A converter 130 then converts the summed channel cancellation output signal to an attenuation control signal provided on the signal attenuation input 134.

Note that in order to relax the dynamic range requirements of the D/A converter 130, the multichannel receiver 100 may instead provide additional D/A converters assigned to subsets of communication channels in the input signal. Thus, at one extreme, as many D/A converters as there are communication channels may provide individual analog attenuation control signals for each communication channel. The individual analog attenuation control signals may be summed together and provided on the signal attenuation input 132. As another approach, one D/A converter may be assigned per unit of spectrum (e.g., one D/A converter per 1 MHz of input signal bandwidth). Alternatively, a selected number of D/A converters may be provided to selectively attenuate communication channels that exceed the predetermined threshold. Thus, for instance, the multichannel receiver 100 may provide eight D/A converters that provide up to eight analog attenuation control signals for up to eight individual channels that exceed the predetermined thresholds.

In implementations where the multichannel receiver 100 includes multiple D/A converters, the multichannel receiver 100 may further include multiple multiplexers or individual implementations of the circuitry 202-208 for each D/A converter or each subset of channels handled by a D/A converter.

Note that a low pass or bandpass filter may optionally follow each D/A converter, and that mixers or other upconverters to a final IF for the multichannel signal attenuator 118 may also be incorporated after the D/A converters.

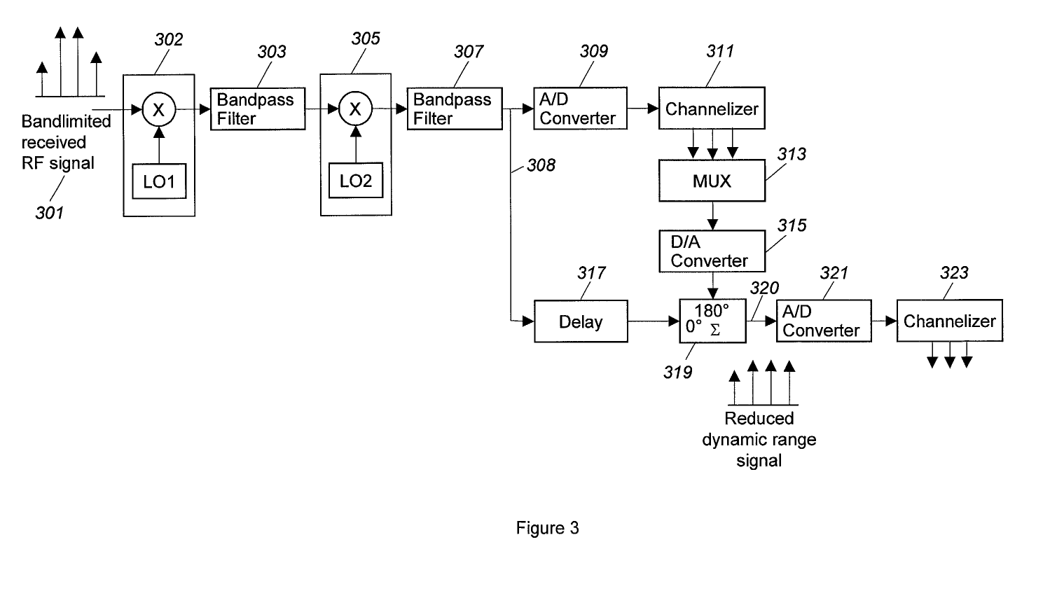

FIG. 3 illustrates a delay compensating multichannel receiver 300 according to an alternative embodiment of the present invention. Similar to FIG. 1 above, the receiver 300 includes a received signal input 301, a first local oscillator and mixer 302, a first bandpass filter 303, an optional second local oscillator and mixer 305, and an optional second bandpass filter 307. The receiver 300 further includes a signal input 308, an analog to digital (A/D) converter 309, a channelizer 311, one or more multiplexers 313, and a digital to analog (D/A) converter 315. Additionally, the receiver 300 includes a delay element 317, a multichannel signal attenuator 319, a second analog to digital (A/D) converter 321, and a second channelizer 323.

The receiver 300 of FIG. 3 is similar to the receiver of FIG. 1, with the addition of the delay element 317 and additional A/D converter 309 and channelizer 311. The receiver 300 minimizes any delay sensitivity that may be experienced by the receiver of FIG. 1. The receiver 300 minimizes delay sensitivity by initially sampling the signal input and delaying the signal input while an amplitude dynamic range control signal is determined for the signal input. The determined amplitude dynamic range control signal is then applied to the delayed signal input. Consequently, the amplitude control signal is applied directly to the signal input that was used to derive it, and not a later signal input. Applying the amplitude control signal directly to the signal input minimizes adverse effects that might be experienced in applications where the received amplitude changes rapidly.

Thus, the delay element 317 preferably induces a delay in the signal input 308 that is the same as the total processing delay through the A/D converter 309, channelizer 311, multiplexers 313, and D/A converter 315. The delay element 317 may be, for example, a Surface Acoustic Wave delay line operating at 180-195 MHz preferably with an insertion loss of less than 20 dB. Preferably, the delay element 317 has a flatness across the 180-195 MHz region of at least 0.5 dB, with less than 100 nanoseconds of time delay ripple.

In the receiver 300 of FIG. 3, the received, bandlimited RF input signal 301 is passed through the first local oscillator and mixer 302 with bandpass filter 303 and the optional local oscillator and mixer 305 with bandpass filter 307 to form the signal input 308, as described above in FIG. 1. The signal input 308 is thus a downconversion of the bandlimited received RF input signal 301.

The input signal 308 is suitable for sampling at the A/D converter 309 without reducing dynamic range. The input signal 308 may be sampled without reducing dynamic range because only larger signals require dynamic range adjustment and the larger signals may be discerned without reducing dynamic range. That is, the ability of the A/D converter 309 to process only a reduced dynamic range is acceptable, even though the input signal 308 has a wide dynamic range, because only the strongest channels present in the input signal 308 need to be isolated by the channelizer 311 and accurately measured for dynamic range adjustment at the multichannel signal attenuator 319. Small power channels present in the signal at the input to A/D converter 309 may be disregarded because the small power channels do not require a dynamic range adjustment.

The output of the A/D converter 309 is coupled to the channelizer 311. At the channelizer 311, the individual channel outputs are compared with the thresholds and the amplitude modification and the frequency translations are determined as described above. The resulting signals are multiplexed together at the multiplexer 313 and then D/A converted at the D/A converter 315 to generate the dynamic range control signal as described in FIGS. 1-2 above.

The dynamic range control signal that is output from the D/A converter 315 and the delayed input signal that is output from the delay element 317 are then applied to the multichannel signal attenuator 319 as shown to form the signal output 320 of the multichannel signal attenuator 319. The signal output 320 of the multichannel signal attenuator 319 is a reduced dynamic range version of the multicarrier input signal 308 which is suitable for sampling using at the A/D converter 321. The output of the A/D converter 321 is then passed to the channelizer 323 so that individual channels may be extracted. The A/D converter 321 may be a reduced dynamic range (e.g., 60 dB) A/D converter.

Thus, the embodiment of FIG. 3 provides the ability to process wide dynamic range multichannel signals while using available reduced dynamic range A/D converter technology. Additionally, the delay sensitivity of the receiver 300 is minimized. The addition of the delay element 317, A/D converter 309, and channelizer 311, while increasing cost of the design, provide a more robust performance by achieving better phase matching of the dynamic range adjustment signal and the input signal 308 at the multichannel signal attenuator 319.

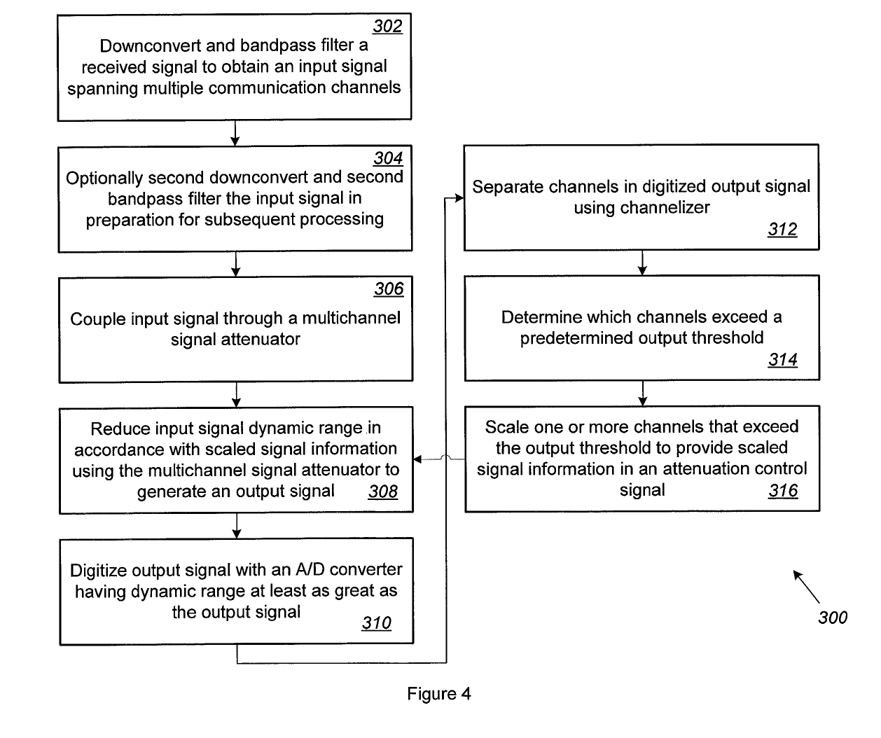

Turning next to FIG. 4, that figure presents a flow diagram 400 for equalizing signal amplitude in an input signal. The flow diagram 400 summarizes the operation of the multichannel receiver 100 discussed above. First, the multichannel receiver 100 downconverts and bandpass filters (402) a transmitted signal to obtain an input signal with input bandwidth spanning multiple communication channels.

The output signal may optionally be further downconverted and bandpass filtered (404) in preparation for subsequent processing including multichannel signal attenuation and digitization. The multichannel receiver 100 then couples (406) the input signal through the multichannel signal attenuator 118. The multiplexer 128 and multichannel signal attenuator 118 reduce (408) the dynamic range of the input signal, thereby producing an output signal.

Subsequently, the A/D converter 122 digitizes (410) the output signal (and therefore all of the communication channels in the input signal). The channelizer 124 may then separate (412) individual channels from the digitized output signal and provide the individual channels on the recovered-channel outputs 128. The back end 104 subsequently determines (414) which channels exceed predetermined output thresholds. In response, the back end 104 scales (416) one or more of the channels that exceed the thresholds to provide scaled signal information in an attenuation control signal.

Thus, the invention provides a multichannel receiver that recovers communication channels in bulk from a received signal. The structure of the multichannel receiver includes a multichannel signal attenuator that reduces dynamic range of an input signal commensurate with a dynamic range capability of an A/D converter. The resultant receiver thus avoids the expense and complication stemming from duplication of individual channel processing chains for each communication channel.

While the invention has been described with reference to one or more preferred embodiments, those skilled in the art will understand that changes may be made and equivalents may be substituted without departing from the scope of the invention. In addition, many modifications may be made to adapt a particular step, structure, or material to the teachings of the invention without departing from its scope, for example by substituting digital processing or signals for analog processing or signals, and vice versa. Therefore, it is intended that the invention not be limited to the particular embodiment disclosed, but that the invention will include all embodiments falling within the scope of the appended claims.

What is claimed is:

1. A multichannel dynamic range adaptor comprising:
a multichannel signal input for carrying an input signal with an input bandwidth spanning multiple communication channels; and
a multichannel signal attenuator connected to the multichannel signal input, the multichannel signal attenuator comprising a signal output and a signal attenuation input responsive to an attenuation control signal;
whereby the multichannel signal attenuator is adapted to provide, on the signal output, an output signal corresponding to the input signal reduced in dynamic range in accordance with the attenuation control signal.

2. The multichannel dynamic range adaptor of claim 1, further comprising an analog to digital (A/D) converter coupled to the multichannel signal attenuator for digitizing the output signal, wherein output signal dynamic range is no greater than A/D converter dynamic range.

3. The multichannel dynamic range adaptor of claim 2, wherein the A/D converter is characterized by an A/D converter bandwidth at least equal to the input bandwidth.

4. A multichannel dynamic range adaptor comprising:
a multichannel signal input for carrying an input signal with an input bandwidth spanning multiple communication channels; and
a multichannel signal attenuator connected to the multichannel signal input, the multichannel signal attenuator comprising a signal output and a signal attenuation input responsive to an attenuation control signal;
whereby the multichannel signal attenuator is adapted to provide, on the signal output, an output signal corresponding to the input signal reduced in dynamic range in accordance with the attenuation control signal;
wherein the multichannel signal attenuator is a reactive power summer.

5. The multichannel dynamic range adaptor of claim 1, wherein the multichannel signal attenuator is operative to subtract the attenuation control signal from the input signal.

6. The multichannel dynamic range adaptor of claim 1, wherein the input bandwidth spans at least 3 channels.

7. The multichannel dynamic range adaptor of claim 1, wherein the attenuation control signal includes signal attenuation information for multiple communication channels.

8. A multichannel dynamic range adaptor comprising:
a multichannel signal input for carrying an input signal with an input bandwidth spanning multiple communication channels; and
a multichannel signal attenuator connected to the multichannel signal input, the multichannel signal attenuator comprising a signal output and a signal attenuation input responsive to an attenuation control signal;
whereby the multichannel signal attenuator is adapted to provide, on the signal output, an output signal corresponding to the input signal reduced in dynamic range in accordance with the attenuation control signal;
wherein the attenuation control signal comprises scaled signal information from a prior input signal.

9. The multichannel dynamic range adaptor of claim 1, further comprising a first local oscillator and mixer for downconverting a received signal, and a first bandpass filter spanning the input bandwidth and coupled to the first mixer.

10. The multichannel dynamic range adaptor of claim 9, further comprising a second local oscillator and mixer coupled to the first bandpass filter for downconverting the output signal, and a second bandpass filter spanning the input bandwidth and coupled to the multichannel signal attenuator.

11. The multichannel dynamic range adaptor of claim 1, wherein the input signal is a radio frequency input signal.

12. A method for modifying dynamic range of an input signal, the method comprising:
obtaining an input signal with an input bandwidth spanning multiple communication channels;
coupling the input signal through a multichannel signal attenuator; and
reducing input signal dynamic range in accordance with an attenuation control signal, thereby generating an output signal on a signal output of the multichannel equalizer.

13. A method according to claim 12, wherein reducing further comprises reducing input signal dynamic range to be no greater than a predetermined dynamic range.

14. A method according to claim 13, further comprising digitizing the output signal with an analog to digital (A/D) converter, and wherein reducing further comprises reducing input signal dynamic range to be no greater than a predetermined dynamic range of the A/D converter.

15. A method according to claim 12, wherein obtaining comprises obtaining a radio frequency input signal.

16. A method for modifying dynamic range of an input signal, the method comprising:
obtaining an input signal with an input bandwidth spanning multiple communication channels;
coupling the input signal through a multichannel signal attenuator; and
reducing input signal dynamic range in accordance with an attenuation control signal, thereby generating an output signal on a signal output of the multichannel equalizer;
wherein obtaining comprises obtaining a radio frequency input signal with an input bandwidth spanning multiple wireless communication channels.

17. A method according to claim 12, further comprising producing the input signal by first downconverting and first bandpass filtering a received signal.

18. A method according to claim 17, further comprising preparing the output signal for digitization by second downconverting and second bandpass filtering the output signal.

19. A method for modifying dynamic range of an input signal, the method comprising:
obtaining an input signal with an input bandwidth spanning multiple communication channels;
coupling the input signal through a multichannel signal attenuator; and
reducing input signal dynamic range in accordance with an attenuation control signal, thereby generating an output signal on a signal output of the multichannel equalizer;
wherein reducing further comprises reducing input signal dynamic range to be no greater than a predetermined dynamic range;
wherein coupling comprises coupling the input signal through a reactive power summer.

20. A method for modifying dynamic range of an input signal, the method comprising:
obtaining an input signal with an input bandwidth spanning multiple communication channels;
coupling the input signal through a multichannel signal attenuator; and
reducing input signal dynamic range in accordance with an attenuation control signal, thereby generating an output signal on a signal output of the multichannel equalizer;
wherein reducing further comprises reducing input signal dynamic range to be no greater than a predetermined dynamic range;
wherein reducing comprises reducing input signal dynamic range in accordance with scaled signal information from a prior input signal.

21. A multichannel receiver comprising:
a multichannel signal input for carrying an input signal with an input bandwidth spanning multiple communication channels;
a multichannel signal attenuator connected to the multichannel signal input, the multichannel signal attenuator comprising a signal output and a signal attenuation input responsive to an attenuation control signal;
whereby the multichannel signal attenuator provides on the signal output an output signal corresponding to the input signal reduced in dynamic range in accordance with the attenuation control signal; and
a channelizer coupled to the analog to digital converter and comprising a plurality of recovered-channel outputs.

22. The multichannel receiver of claim 21, further comprising a multiplexer coupled to the recovered-channel outputs for providing a summed channel cancellation output signal.

23. The multichannel receiver of claim 22, further comprising a digital to analog converter coupled between the multiplexer and the signal attenuation input.

24. A multichannel receiver comprising:
a multichannel signal input for carrying an input signal with an input bandwidth spanning multiple communication channels;
a multichannel signal attenuator connected to the multichannel signal input, the multichannel signal attenuator comprising a signal output and a signal attenuation input responsive to an attenuation control signal;
whereby the multichannel signal attenuator provides on the signal output an output signal corresponding to the input signal reduced in dynamic range in accordance with the attenuation control signal; and
a channelizer coupled to the analog to digital converter and comprising a plurality of recovered-channel outputs;
further comprising a multiplexer coupled to the recovered-channel outputs for providing a summed channel cancellation output signal;
wherein the summed channel cancellation output signal comprises recovered-channel signal data from at least one recovered-channel signal with an output level exceeding a predetermined threshold.

25. The multichannel receiver of claim 24, wherein the output level is average power in the recovered-channel signal.

26. A multichannel receiver comprising:
a multichannel signal input for carrying an input signal with an input bandwidth spanning multiple communication channels;
a multichannel signal attenuator connected to the multichannel signal input, the multichannel signal attenuator comprising a signal output and a signal attenuation input responsive to an attenuation control signal;
whereby the multichannel signal attenuator provides on the signal output an output signal corresponding to the input signal reduced in dynamic range in accordance with the attenuation control signal; and
a channelizer coupled to the analog to digital converter and comprising a plurality of recovered-channel outputs;
further comprising a multiplexer coupled to the recovered-channel outputs for providing a summed channel cancellation output signal;
wherein the summed channel cancellation output signal comprises recovered-channel signal data from at least two recovered-channel signals, each with an output level exceeding a predetermined threshold.

27. The multichannel receiver of claim 22, wherein the multiplexer comprises an amplitude modification circuit.

28. The multichannel receiver of claim 22, wherein the multiplexer comprises a frequency translation circuit.

29. The multichannel receiver of claim 22, wherein the multiplexer comprises a signal summation circuit.
